(19) United States
(12) Patent Application Publication
(10) Pub. No.: US 2011/0057028 A1
(43) Pub. Date: Mar. 10, 2011

(54) SYSTEM AND METHOD FOR MULTI-TICKET SYSTEM REDEMPTION

(75) Inventor: Andrew J. Schwartz, Chester Springs, PA (US)

(73) Assignee: AUTOMATED CURRENCY INSTRUMENTS, INC., Exton, PA (US)

(21) Appl. No.: 12/875,286

(22) Filed: Sep. 3, 2010

Related U.S. Application Data
(60) Provisional application No. 61/239,834, filed on Sep. 4, 2009.

(51) Int. Cl. G07D 7/00

(52) U.S. Cl. 235/379

(57) ABSTRACT

A method for redeeming a voucher generated by a first system in a second system is disclosed. The method comprises the steps of receiving the voucher; reading the voucher; determining that the voucher was generated by the first system; redeeming the voucher on the first system for a value; and issuing a credit on the second system for the value. A system for redeeming the voucher is also disclosed.

### CROSS REFERENCE TO RELATED APPLICATIONS

This application claims the benefit of U.S. Provisional Application No. 61/239,834, filed Sep. 4, 2009.

### FIELD OF INVENTION

The present invention relates generally to casino gaming, and more specifically, to a system and method for redeeming tickets in a casino environment in which gaming machines are supported by multiple backend systems.

### BACKGROUND

In modern casino gaming, many casinos use gaming machines configured to operate using a slot accounting/management system to implement cashless gaming, otherwise known as “ticket in ticket out” (TITO) gaming. A casino patron obtains credits on a TITO gaming machine by inserting either cash or a voucher into a bill validator contained within the machine. In the case of the voucher, the bill validator reads the voucher and communicates with the slot accounting/management server to determine the value of the voucher and issue a credit in the machine. When the patron is finished playing the machine, the machine generates a voucher equal to the value of any remaining credits.

Currently, in some applications, each manufacturer of TITO gaming machines uses its own slot accounting/management server to manage TITO transactions for its own TITO gaming machines. Accordingly, in a casino in which TITO gaming machines from more than one manufacturer are in use, TITO gaming machines from one vendor often cannot accept or generate a voucher from other vendors' slot accounting/management system. This incompatibility creates several challenges for patrons, as well as casino employees. For example, a patron having a voucher issue on one vendor's slot accounting/management system who wants to play another vendor's gaming machine must either go to a casino cage or find a casino employee to either cash the voucher or trade it for a new voucher. This requirement is time consuming and frustrating to the patron, and leads to potential revenue loss for the casino while the patron is walking to and from the cage or looking for an employee.

### BRIEF DESCRIPTION OF THE DRAWINGS

The foregoing summary, as well as the following detailed description of the invention, will be better understood when read in conjunction with the appended drawings. For the purpose of illustrating the invention, there are shown in the drawings certain embodiments of the present invention. It should be understood, however, that the invention is not limited to the precise arrangements and instrumentalities shown. In the drawings, the same reference numerals are employed for designating the same elements throughout the several figures. In the drawings:

FIG. 1 is a schematic drawing of a system for redeeming or generating vouchers from multiple casino game vendors, according to an exemplary embodiment of the present invention;

FIG. 2 is a flow chart illustrating an exemplary method for redeeming casino gaming vouchers, according to the present invention;

FIG. 3 is a flow chart illustrating an alternative exemplary embodiment of a method for redeeming casino gaming vouchers, according to the present invention;

FIG. 4 is a flow chart illustrating another alternative exemplary embodiment of a method for redeeming casino gaming vouchers, according to the present invention;

FIG. 5 is a schematic drawing illustrating an alternative exemplary embodiment of a system for redeeming casino gaming vouchers, according to the present invention;

FIG. 5A is a schematic drawing of a bill validator connection to its associated gaming machine according to the prior art;

FIG. 5B is a schematic drawing of a bill validator connection to its associated gaming machine according to an exemplary embodiment of the present invention;

FIG. 6 is a flowchart illustrating yet another alternative exemplary embodiment of a method for redeeming casino gaming vouchers, according to the present invention; and

FIG. 7 is a schematic drawing illustrating another alternative exemplary embodiment of a system for redeeming casino gaming vouchers, according to the present invention.

### DETAILED DESCRIPTION OF EXEMPLARY EMBODIMENTS

In describing the embodiments of the invention illustrated in the drawings, specific terminology will be used for the sake of clarity. However, the invention is not intended to be limited to the specific terms so selected, it being understood that each specific term includes all technical equivalents operating in similar manner to accomplish similar purpose. It is understood that the drawings are not drawn exactly to scale. In the drawings, similar reference numbers are used for designating similar elements throughout the several figures.

The following describes particular embodiments of the present invention. It should be understood, however, that the invention is not limited to the embodiments detailed herein. Generally, the following disclosure refers to systems and methods for redeeming gaming vouchers in casinos that use machines from different vendors. The present system may be incorporated into existing gaming machines or, alternatively, the system may be incorporated into newly manufactured machines. The systems and methods of the present invention consolidate all casino cage processing functions into a central point to share hardware, ease staff training, and provide a common point of transaction processing for many casino functions, such as, for example, voucher processing (redemption and generation), cash access transactions, club enrollments, black list verification, Title 31 tracking, check cashing, game chip purchase and redemption, employee banking, reporting, auditing, password management, club promotions, point of sale, bill breaking, and valet processing.

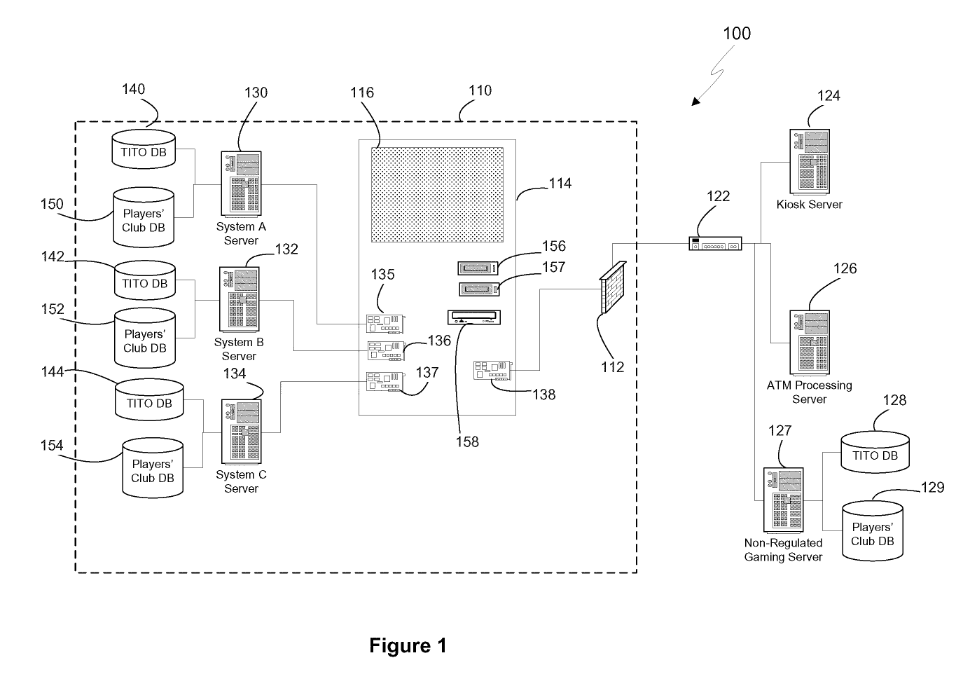

Referring now to the drawings, a first embodiment of a multi-ticket redemption system 100 (“system 100”) according to an exemplary aspect of the present invention is shown. System 100 includes a regulated portion 110, bounded by the dashed box in FIG. 1, which is regulated by a state gaming commission of the state in which the system is located. Exemplary machines that may be regulated by a state gaming commission include slot machines and video poker games.

System 100 also includes an unregulated portion 120, outside of the dashed box in FIG. 1, which is not regulated by the state gaming commission. Exemplary machines that are not typically regulated by a state gaming commission may be automated teller machines (ATM) and bingo games. Regulated portion 110 may be separated from unregulated portion 120 by a firewall 112, such as, for example, a model TZ 180 firewall manufactured by Sonicwall, Inc. of San Jose, Calif.

Regulated portion 110 includes an automatic ticket redemption (ATR) kiosk 114 that is used to redeem gaming vouchers from more than one machine vendor. For example, FIG. 1 illustrates an exemplary embodiment, wherein gaming machine servers 130, 132, 134 from three (3) different machine vendors are electronically coupled to kiosk 114. The term “electronically coupled” means that one machine is able to transfer information to/from another machine. Electronic coupling may be performed by an actual hardwire connection, a wireless connection, or other suitable mechanism to provide for data transfer between the machines. A plurality of kiosks 114 may be strategically located around a casino floor to provide access for casino patrons. Kiosks 114 may also be located within casino cashier cages to allow casino employees access to system 100. Kiosks 114 allow a patron to purchase/redeem game credits, sign up for the casino's player's club, act as an ATM to allow the patron to withdraw cash, and other features as will be described in more detail herein.

Kiosk 114 provides a backend system that allows communication among multiple servers 130, 132, 134. In an exemplary embodiment, servers 130, 132, 134 may be associated with different vendors. In an alternative exemplary embodiment, servers 130, 132, 134 may not necessarily be associated with different vendors, but must each service different gaming machines for regulatory reasons. For example, for a casino that may cross state lines, one server may service gaming machines in one state, and another server may service gaming machines in the other state.

Kiosk 114 includes a monitor 116 that allows a user, such as a casino patron, to view options for using kiosk 114, such as, for example, for purchasing/redeeming a casino voucher. Monitor 116 may be a touch screen to allow the user to interact with kiosk 114 through monitor 116.

Kiosk 114 may include a separate network interface card (NIC) 135, 136, 137, 138 for each of gaming machine servers 130, 132, 134 and firewall 112, respectively. Each server 130, 132, 134 has its own separate ticket-in/ticket-out (TITO) database 140, 142, 144, respectively, and its own separate player's club database, 150, 152, 154, respectively. TITO databases 140, 142, 144 store information about the usage of each machine coupled to its respective server 130, 132, 134. Player's club databases 150, 152, 154 store information about casino patrons who have enrolled in a casino's gaming system. This patron information may include the patron's name, address, and gaming history, which allows a casino to provide services to the patrons, such as, for example, to offer discounts or incentives to gamble. For security reasons, servers 130, 132, 134 are typically each located on a different subnet. Accordingly, none of servers 130, 132, 134, TITO databases 140, 142, 144, or player's club databases 150, 152, 154 connect or communicate directly with servers or databases from other vendors, so kiosk 114 is used as a buffer and an interface to provide transactions between different vendor's machines. Kiosk 114 further includes a bill/ticket validator 156 that accepts currency, smart cards, or vouchers. A dispenser 157 in kiosk 114 dispenses cash or vouchers to the patron. A credit card reader 158 allows the patron to use a credit card to purchase gaming credits.

Unregulated portion 120 of system 100 may include a router 122 that couples non-regulated servers, such as, for example, a kiosk server 124, an ATM processing server 126, and a non-regulated gaming server 127 through firewall 112 to kiosk 114. Non-regulated gaming server 127 may include a TITO database 128 and a player's club database 129.

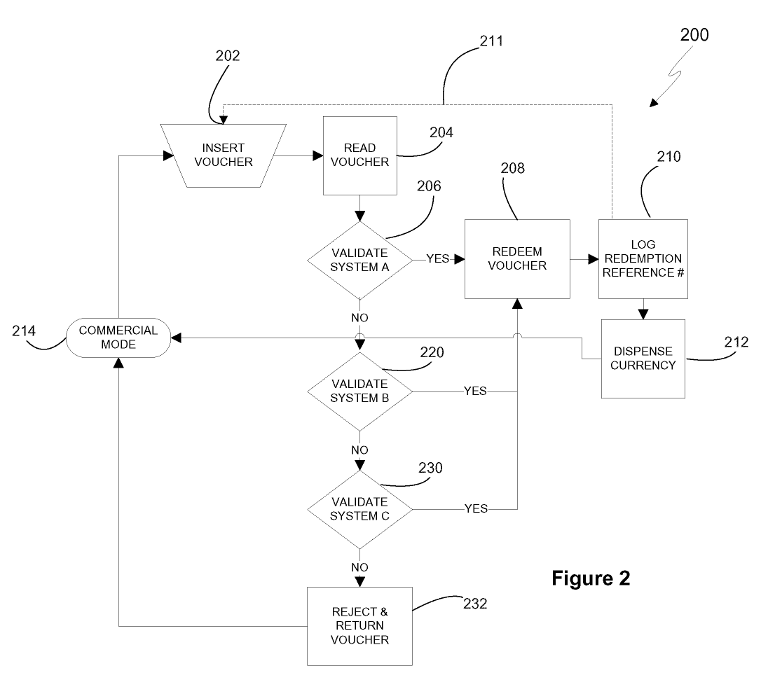

Read in conjunction with FIG. 1, FIG. 2 provides a flowchart illustrating an exemplary method 200 of cashing in a gaming voucher. Method 200 may start with step 202, when a casino patron inserts a voucher into bill/ticket validator 156 in kiosk 114. In step 204, kiosk 114 reads the voucher and, in step 206, attempts to validate the voucher in a first vendor's voucher system (i.e., system A). If the voucher was generated by one of system A's machines, kiosk 114 will be able to read the voucher and, in step 208, the voucher will be redeemed. In step 210, kiosk 114 will log a redemption reference number for the transaction, which is used to track and record the redemption. Step 212 dispenses currency to the patron commensurate with a value on the voucher. In step 214, the patron will be able to use the currency provided in step 212 in a commercial mode, such as, for example, to play another game. If the patron has more than one voucher to validate, in step 211, the patron can insert additional vouchers into kiosk 114, which can then be aggregated to a final total prior to dispensing currency in step 212.

If, in step 206, system A is unable to validate the voucher, such as, for example, if the voucher was generated by another vendor's machine, in step 220, kiosk 114 attempts to validate the voucher in a second vendor's voucher system (i.e. system B). If the voucher was generated by one of system B's machines, kiosk 114 will be able to read the voucher and, step 208 will redeem the voucher. If, however, system B is unable to validate the voucher, in step 230, kiosk 114 attempts to validate the voucher in a third vendor's voucher system (i.e. system C). If the voucher was generated by one of system C's machines, kiosk 114 will be able to read the voucher and step 208 will redeem the voucher.

Kiosk 114 will attempt to serially validate the voucher for all of the different systems that are electronically coupled to kiosk 114. If, however, after unsuccessfully attempting to valid the voucher in all of the different vendors' machines that are electronically coupled to kiosk 114, step 232 will reject and return the voucher to the patron. The patron may then take the voucher to a casino employee to resolve redemption issues.

The patron may alternatively use kiosk 114 to cash out a voucher when he/she has finished playing the casino games. Upon validating the voucher and upon request for cash by the patron, kiosk 114 can dispense cash to the patron via dispenser 157.

While three vendors are described with respect to method 200, those skilled in the art will recognize that machines that are provided by more or less than three vendors may be electronically coupled to kiosk 114 without departing from the scope of the present invention.

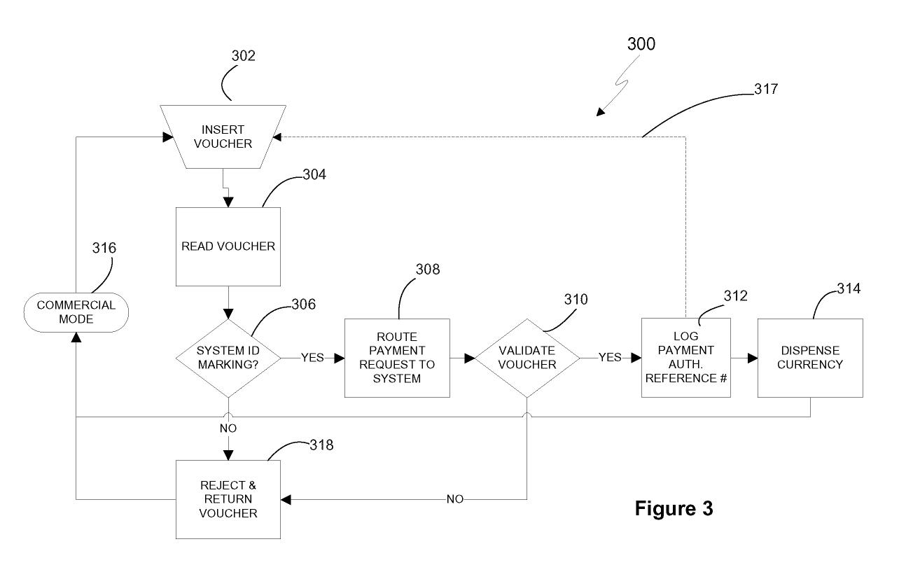

FIG. 3 provides a flowchart illustrating an alternative exemplary method 300 of cashing in a gaming voucher. Method 300 may start with step 302, when a casino patron inserts a voucher into kiosk 114. In step 304, kiosk 114 reads the voucher and in step 306 searches for a vendor identification indicia printed on the voucher. Different indicia may be printed on each voucher to identify a particular vendor. For example, the indicia may be in the form of a multi-digit number on the voucher, wherein predetermined digits in that number are used to identify a particular vendor. For example, the voucher may include an 18-digit number, with the first two digits being used to identify the vendor. Alternatively, the indicia may be in the form of a barcode of other suitable indicia that can be used to distinguish between vouchers issued by different vendors' machines.

If kiosk 114 identifies the vendor that issued the particular voucher, step 308 routes a payment request to that vendor to validate the voucher in step 310. If the voucher is validated, in step 312, kiosk 114 will log a redemption reference number for the transaction and in step 314 will dispense currency to the patron commensurate with a value on the voucher. In step 316, the patron will be able to use the currency provided in step 314 in a commercial mode, such as, for example, to play another game. If the patron has more than one voucher to validate, in step 317, the patron can insert additional vouchers into kiosk 114, which can then be aggregated to a final total prior to dispensing currency in step 314.

If, in step 306, kiosk 114 is unable to identify the indicia as being associated with a particular vendor (i.e. system A, system B, system C), or in step 310 is otherwise unable to validate the voucher, step 318 rejects the voucher and returns the voucher to the patron. Optionally, the kiosk 114 may prompt the patron to take the voucher to a casino employee to resolve the redemption issue.

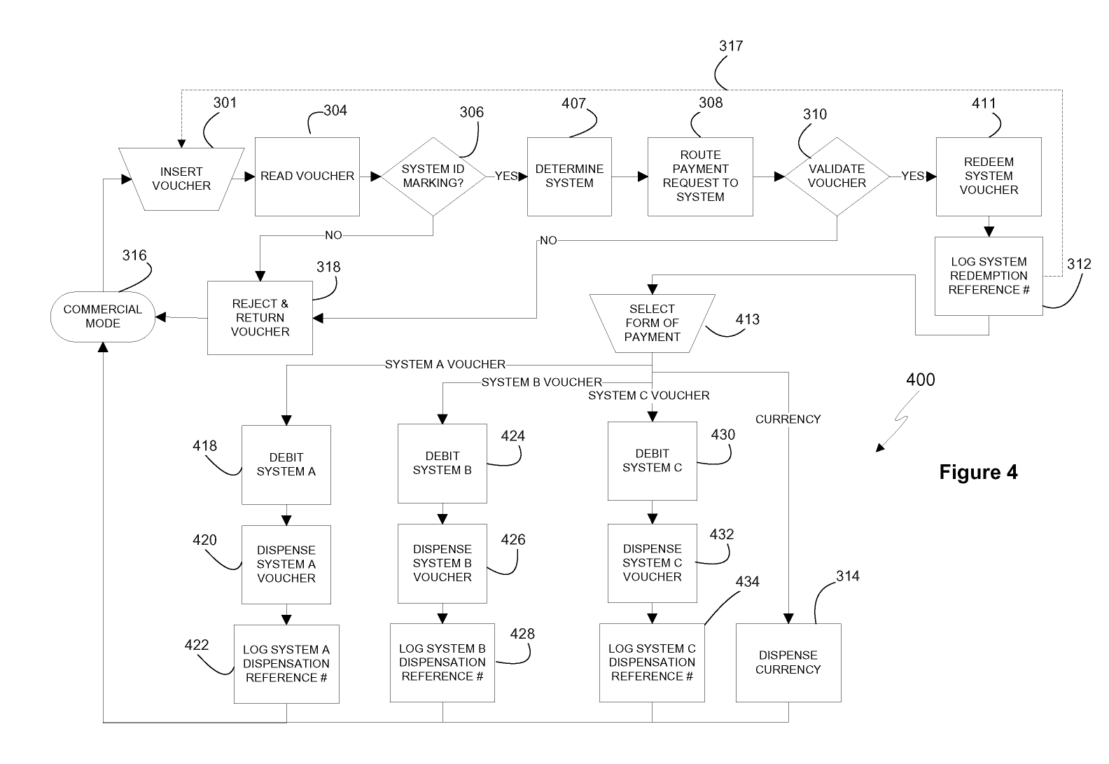

FIG. 4 provides a flowchart illustrating an alternative exemplary method 400 of cashing in a gaming voucher. Method 400 is similar to method 300 described above, but provides additional features, which are presently described. After step 306, step 407 determines which vendor's system is associated with the voucher prior to step 308 routing a payment request to that particular system.

After step 310, in step 411 the vendor redeems the voucher prior to step 312 logging the redemption reference number. After step 312, step 413 allows the patron to select the form of payment for the voucher. This selection may be by touching monitor 116 on kiosk 114 (illustrated in FIG. 1). In addition to step 314, which dispenses currency to the patron, the patron may select system A, thereby debiting system A in step 418. Step 420 dispenses a voucher to the patron for use with system A and step 422 logs a dispensation reference number for the transaction.

Alternatively, in step 413, the patron may select a system B, thereby debiting system B in step 424. Step 426 dispenses a voucher to the patron for use with system B and step 428 logs a dispensation reference number for the transaction. Still alternatively, in step 413, the patron may select system C, thereby debiting system C in step 430. Step 432 dispenses a voucher to the patron for use with system C and step 434 logs a dispensation reference number for the transaction.

While three vendors are described with respect to method 400, those skilled in the art will recognize that machines that are provided by more or less than three vendors may be electronically coupled to kiosk 114 without departing from the scope of the present invention. Further, while step 314 discloses dispensing currency and steps 420, 426, and 432 disclose dispensing vouchers for respective vendor machines, those skilled in the art will recognize that method 400 may also dispense casino chips, electronic chips, debit cards, or other cash-equivalent-type objects.

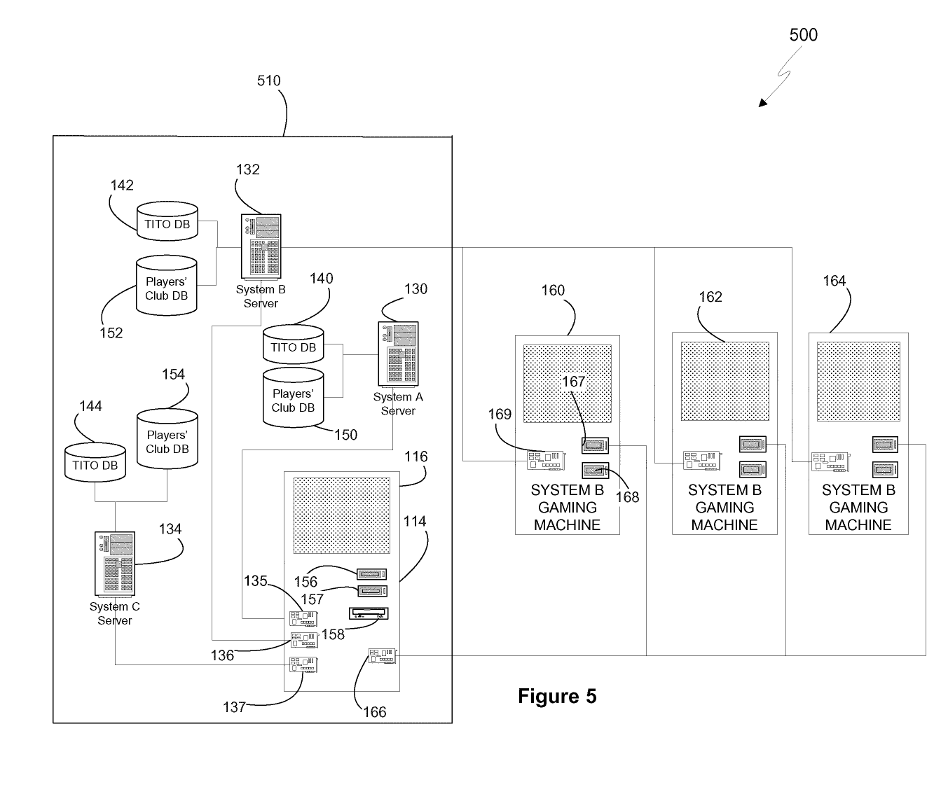

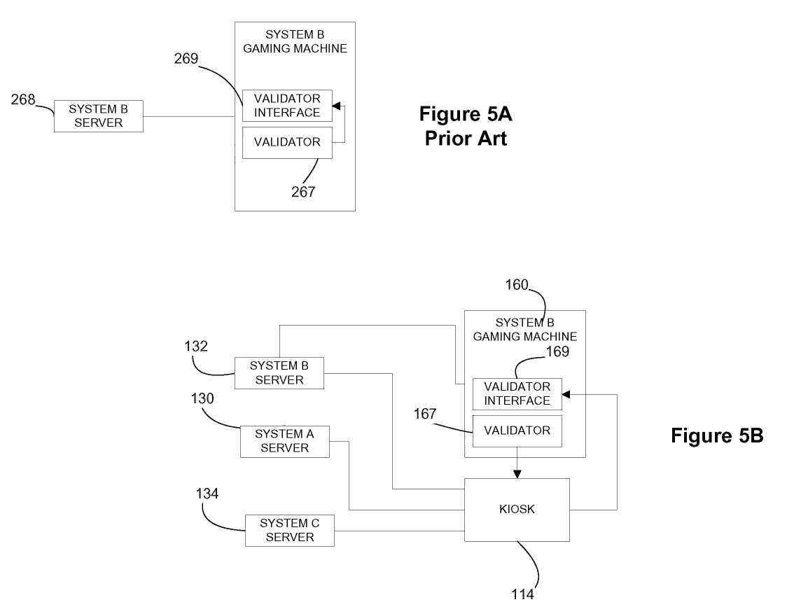

Referring to FIG. 5, in an alternative embodiment of a system 500 according to the present invention, kiosk 114 may be electronically coupled to a plurality of gaming machines 160, 162, 164 that operate in a single gaming system (i.e. system B), as well as to servers 130, 132, 134. Kiosk 114 may include a single NIC 166 that services all of machines 160, 162, 164. Alternatively, although not shown, kiosk 114 may include a separate NIC for each of machines 160, 162, 164. Those skilled in the art will recognize that, while three machines 160, 162, 164 are illustrated in FIG. 5, more or less than three machines may be used. Also, a regulated portion 510 of system 500 may be identical to regulated portion 110 illustrated in FIG. 1. In addition, other suitable types of interfaces may be used to link the kiosk 114 to the gaming machines 160,162,164.

Machine 160 includes a bill/voucher validator 167 that a patron uses to insert money or a voucher to add gaming credits to machine 160. Machine 160 also includes a voucher dispenser 168 that prints a voucher for the patron when the patron is finished playing machine 160. Machines 160, 162, 164 may be situated next to each other in a row on a casino floor, with kiosk 114 situated at an end of the row. Machines 160, 162, 164 may each be electronically coupled to server 132 as well as to kiosk 114 so that server 132 can monitor the use of machines 160, 162, 164.

FIG. 5A is a simplified block diagram showing a prior art gaming machine 260 having a validator 267 and being coupled to a gaming server 268. When a patron inserts a voucher into validator 267, the validator 267 reads indicia on the voucher and transmits information associated with the indicia to the machine 260 via a validator interface 269. The gaming machine 260 then communicates with server 268 to determine whether the voucher is legitimate and, if so, calculates and provides the number of credits associated with the value of the voucher. Prior art validator 267 was limited in reading only vouchers generated by the system to which the machine 160 is connected (in this case system B).

FIG. 5B is a simplified block diagram showing how the kiosk 114 of FIG. 5 interfaces with the validator 167 of machine 160. The output from validator 167 of gaming machine 160 is electronically coupled to the kiosk 114, instead of a validator interface in the gaming machine 160. Kiosk 114 then identifies the voucher (using one of the methods outlined in FIGS. 3 through 5, for example). If the voucher is associated with the system to which the machine 160 is connected (in this case, system B), the kiosk 114 transmits information associated with the indicia to the validator interface 169 of the machine 160 and the machine 160 further processes the voucher in the same way as machine 260. If the voucher is not associated with the system to which the machine 160 is connected, the kiosk 114 redeems the voucher, issues a new voucher on the system associated with the gaming machine 160 (using the method outlined in FIG. 4, for example) and transmits the new voucher indicia to the gaming machine 160. Accordingly, this configuration allows a patron to play machine 160 regardless of which vendor's system generated the voucher inserted by the patron.

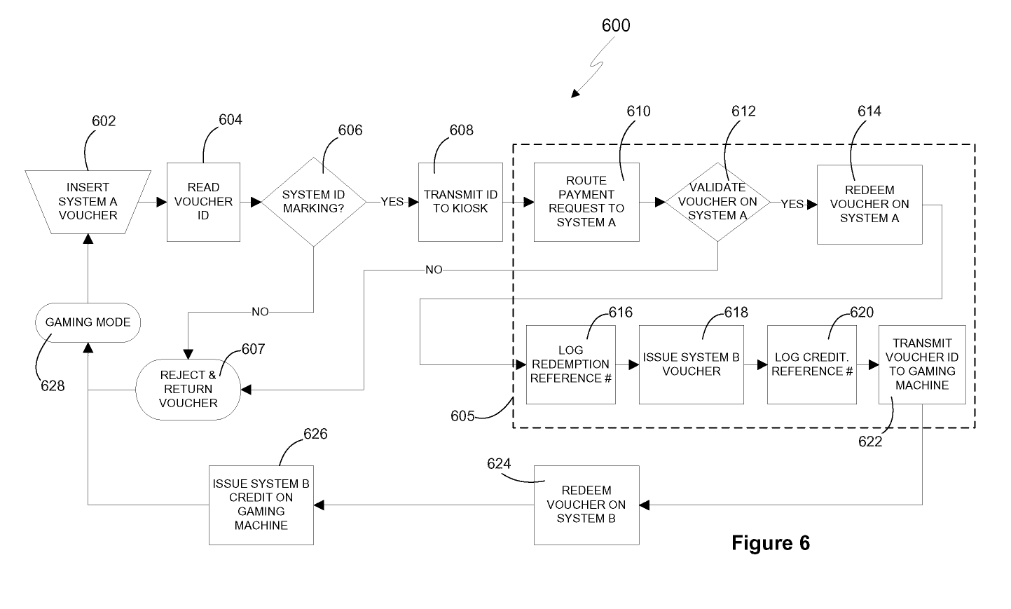

Viewed in conjunction with FIG. 5, FIG. 6 provides a flowchart illustrating an alternative exemplary method 600 of using in a gaming voucher issued by system A server 130 on a machine 160, which is connected only to the system B server 132. In step 602, a casino patron inserts a voucher issued by system A into a bill/ticket validator 167 in system B's machine, such as, for example, machine 160. In step 604, the validator 167 reads the voucher and, in step 606 determines whether the voucher includes a recognizable identifier (such as a bar code having unique identification number). If the validator 167 does not detect a recognizable identifier on the voucher, the validator 167 rejects the voucher and returns it to the patron (step 607). Optionally, the gaming machine 160 may prompt the patron to take the voucher to a casino employee to resolve the redemption issue.

If the validator 167 detects a recognizable identifier on the voucher, the validator 167 transmits the identifier to the kiosk 114 (step 608). The kiosk 114 then routes a payment request to system A server 130 to “zero” the voucher (step 610). The system A server 130 then validates the voucher (step 612) and, if the identifier is determined to be valid, redeems the voucher (step 614) and the kiosk 114 logs a redemption reference number (step 616).

In step 618, the kiosk 114 directs system B server 132 to issue a new system B voucher (in the same amount as the voucher redeemed on system A) and a logs the credit reference number (step 620). The kiosk 114 then transmits the identifier for the system B voucher to the gaming machine 160 (step 622). The gaming machine 160 then redeems the voucher (step 624), issues a credit in the amount of the voucher (step 626) and the gaming machine 160 returns to gaming mode (step 628).

As set forth above, the kiosk 114 “intercepts” the voucher identifier information from the validator 167 and, when necessary, redeems the voucher and obtains a new voucher on the gaming system associated with the gaming machine 160—all in a manner that is transparent to the gaming machine 160. Said another way, the steps located inside box 605 of FIG. 6 are carried out via the kiosk 114 and not through the gaming machine 160. Such transparency may enable the gaming machine 160 to accept vouchers issued on multiple gaming systems without having to be recertified by gaming commission authorities, which would likely be required if the gaming machine 160 was modified to carry out these steps internally.

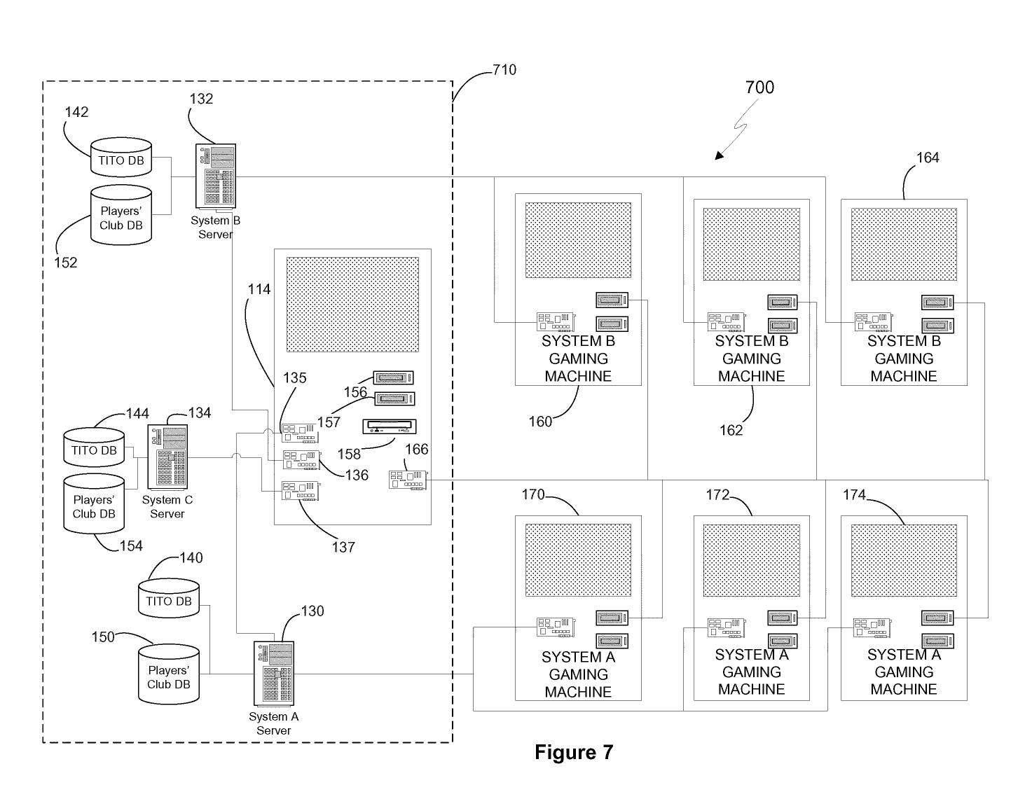

FIG. 7 is a schematic illustration of yet another alternative embodiment of a system 700 according to the present invention. Kiosk 114 may be electronically coupled to a plurality of gaming machines 160, 162, 164 from system A and a plurality of gaming machines 170, 172, 174 from system B, as well as to servers 130, 132, 134. Kiosk 114 may include a single NIC 166 that services all of machines 160, 162, 164, 170, 172, 174. Alternatively, although not shown, kiosk 114 may include a separate NIC for each of machines 160, 162, 164, 170, 172, 174. Those skilled in the art will recognize that, while six machines 160, 162, 164, 170, 172, 174 are illustrated in FIG. 7, more or less than six machines may be used.

Machines 160, 162, 164, 170, 172, 174 may be situated next to or proximate to each other, such as in a row, or back-to-back on a casino floor, with kiosk 114 situated at an end of the row. Machines 160, 162, 164 may each be electronically coupled to server 132 as well as to kiosk 114 so that server 132 can monitor the use of machines 160, 162, 164. Machines 170, 172, 174 may each be electronically coupled to server 130 as well as to kiosk 114 so that server 130 can monitor the use of machines 170, 172, 174. Also, a regulated portion 710 of system 700 may be identical to regulated portion 110 illustrated in FIG. 1.

Although the present invention has been described as including systems and methods for reading a gaming voucher generated by a first vendor's machine and providing a voucher for use on a second vendor's machine, the present invention also provides for converting the first machine's voucher into a standard voucher that can be used on any machine, as well as for converting the voucher to currency. Additionally, a standard voucher or a voucher for a particular vendor's machines may be purchased with currency through kiosk 114.

The invention described above reduces the amount of hardware required to operate a casino that uses machines from more than one vendor and also simplifies reconciliation reports. The invention further provides a single point of redemption for a multitude of systems, which eases patron interaction with the machines, resulting in more gaming time for the patrons. The inventions also reduces the amount of cash transactions by allowing the patrons the ability to convert one vendor's voucher for use on another vendor's machines, thereby reducing the amount of cash that casino employees will be required to carry and exchange in return for vouchers.

It will be appreciated by those skilled in the art that changes can be made to the embodiments described above without departing from the broad inventive concept thereof. It is understood, therefore, that this invention is not limited to the particular embodiments enclosed, but is intended to cover modifications within the sphere and scope of the present invention.

What is claimed is:

1. A method for redeeming a voucher generated by a first system in a second system, the method comprising the steps of:
a) receiving the voucher;
b) reading the voucher;
c) determining that the voucher was generated by the first system;
d) redeeming the voucher on the first system for a value; and
e) issuing a credit on the second system for the value.

2. A system for redeeming a voucher generated by a first system in a second system, the system comprising:
a) means for receiving the voucher;
b) means for reading the voucher;
c) means for determining that the voucher was generated by the first system;
d) means for redeeming the voucher on the first system for a value; and
e) means for issuing a credit on the second system for the value.
